(19) United States
(12) Patent Application Publication
(10) Pub. No.: US 2025/0239856 A1
(43) Pub. Date: Jul. 24, 2025

(54) POWER CONVERSION SYSTEM

(71) Applicant: Mitsubishi Electric Corporation, Tokyo (JP)

(72) Inventors: Yu KAWAI, Chiyoda-ku, Tokyo (JP); Kikuo IZUMI, Chiyoda-ku, Tokyo (JP)

(73) Assignee: Mitsubishi Electric Corporation, Tokyo (JP)

(21) Appl. No.: 18/700,710

(22) PCT Filed: Oct. 21, 2021
(86) PCT No.: PCT/JP2021/038935

§ 371 Date: Apr. 12, 2024

(51) Int. Cl. H02J 3/32; H02J 3/38; H02J 7/00; H02M 7/44

(52) U.S. Cl. CPC H02J 3/32; H02J 3/38; H02J 7/007; H02M 7/44; H02J 2207/20

(57) ABSTRACT

A power conversion system includes: a power storage element; a first power converter to control charging and discharging of the power storage element, and output an AC voltage to the load; a first controller to control the first power converter; a power generation element to supply generated power; a second power converter to output an AC voltage to the load; and a second controller to control the second power converter. The first controller instructs the first power converter to adjust the AC voltage on the AC terminal in accordance with a first table based on a state of charge of the power storage element, and the second controller instructs the second power converter to adjust AC current output to the AC terminal in accordance with a second table based on change of a state of the AC voltage on the AC terminal.

### TECHNICAL FIELD

The present disclosure relates to a power conversion system including a power storage element.

### BACKGROUND ART

For a power conversion apparatus including a power storage element with a load side connected with a grid-connected device during isolated operation, it is desirable that the grid-connected device including a power generation element is stopped when the state of charge of the power storage element increases, to prevent isolated operation from being stopped due to restriction on charging of the power storage element and continue power supply to an essential load.

Japanese Patent Laying-Open No. 2014-180159 (PTL 1) discloses a method for stopping a grid-connected device including a power generation element during isolated operation by using the islanding operation function of the grid-connected device.

The above-referenced publication discloses a technique that enables continuation of power supply to an essential load by satisfying a condition for stopping the grid-connected device including the power generation element when the state of charge of the power conversion apparatus including the power storage element increases.

### CITATION LIST

### Patent Literature

PTL 1: Japanese Patent Laying-Open No. 2014-180159

### SUMMARY OF INVENTION

### Technical Problem

In connection with the above-described technique, a technique is proposed for disconnecting and re-connecting the grid-connected device in response to change of the output voltage of a power converter based on the state of charge of the power storage element.

However, if the grid-connected device including the power generation element is disconnected and re-connected suddenly regardless of the state of charge of the power storage element, the power supplied from the power converter may change suddenly, resulting in unwanted power variation of an isolated grid.

An aspect of the present disclosure is given to solve the problems as described above, and an object thereof is to provide a power conversion system capable of suppressing unwanted power variation of an isolated grid.

### Solution to Problem

A power conversion system according to an embodiment includes: a power storage element; a first power converter connected between the power storage element and a load, to control charging and discharging of the power storage element, and output an AC voltage to the load; a first controller to control the first power converter; a power generation element to supply generated power; a second power converter connected, at an AC terminal, to the load in parallel with the first power converter, to output an AC voltage to the load; and a second controller to control the second power converter. The first controller instructs the first power converter to adjust the AC voltage on the AC terminal in accordance with a first table based on a state of charge of the power storage element or based on an internal state of the first power converter, and the second controller instructs the second power converter to adjust AC current output to the AC terminal in accordance with a second table based on change of a state of the AC voltage on the AC terminal.

### Advantageous Effects of Invention

The power conversion system according to the present disclosure is capable of suppressing unwanted power variation of an isolated grid.

### BRIEF DESCRIPTION OF DRAWINGS

FIG. 1 is a diagram illustrating a configuration of a power conversion system 100 according to Embodiment 1.

FIG. 2 is a diagram illustrating a first table and a second table for a first controller 3 and a second controller 5 according to Embodiment 1.

FIG. 3 is another diagram illustrating a first table and a second table for first controller 3 and second controller 5 according to Embodiment 1.

FIG. 4 is still another diagram illustrating a first table and a second table for first controller 3 and second controller 5 according to Embodiment 1.

FIG. 5 is a diagram illustrating a configuration of a power conversion system 110 according to Embodiment 2.

FIG. 6 is a diagram illustrating a configuration of a power conversion system 120 according to Embodiment 3.

FIG. 7 is a diagram illustrating a configuration of a power conversion system 200 according to Embodiment 4.

FIG. 8 is a diagram illustrating adjustment of parameters by first controllers 3a, 3b and second controllers 5a, 5b according to Embodiment 4.

FIG. 9 is a diagram illustrating another adjustment of parameters by first controllers 3a, 3b and second controllers 5a, 5b according to Embodiment 4.

### DESCRIPTION OF EMBODIMENTS

Embodiments are described hereinafter based on the drawings. In the following description, the same parts are denoted by the same reference characters. They are named and function identically, and therefore, a description thereof is not herein repeated.

### Embodiment 1

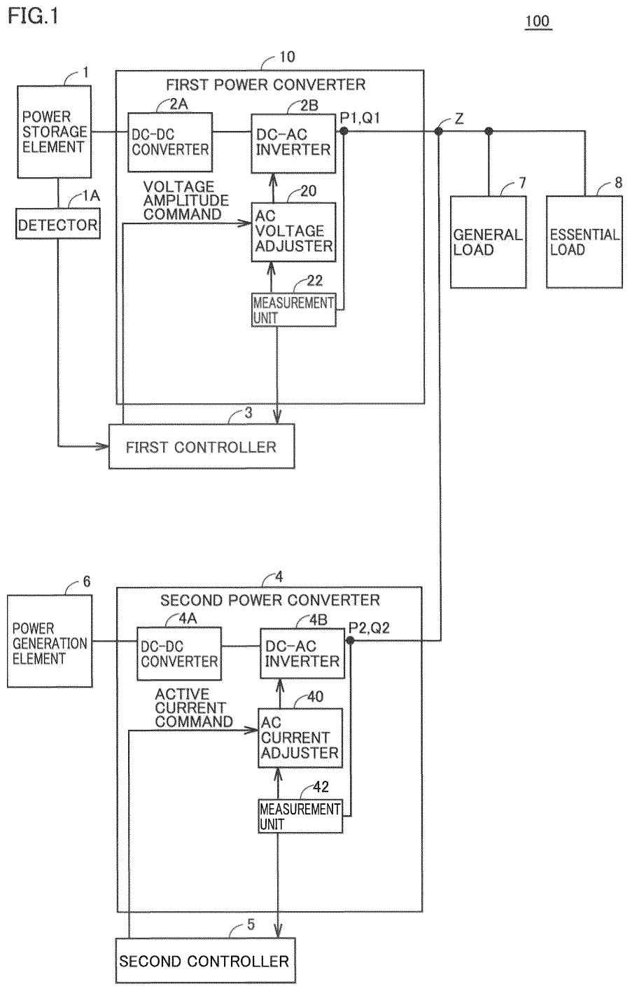

FIG. 1 is a diagram illustrating a configuration of a power conversion system 100 according to Embodiment 1. As shown in FIG. 1, power conversion system 100 includes a power storage element 1, a first power converter 10, a first controller 3 that controls first power converter 10, a power generation element 6 that supplies generated power, a second power converter 4, a second controller 5 that controls second power converter 4, and a detector 1A. A general load 7 and an essential load 8 (hereinafter also referred to as load) are further provided.

First power converter 10 is connected between power storage element 1 and the load, controls charging and discharging of power storage element 1, and outputs an AC voltage to the load.

First power converter 10 includes a DC-DC converter 2A that receives a DC voltage from power storage element 1 and converts the received DC voltage to a DC voltage, a DC-AC converter 2B that receives the DC voltage from DC-DC converter 2A and outputs an AC voltage to an AC terminal, an AC voltage adjuster 20 that adjusts the AC voltage output from DC-AC inverter 2B, and a measurement unit 22 that measures the AC voltage on AC terminal Z.

Second power converter 4 is connected, at AC terminal Z, to the load in parallel with first power converter 10, and outputs an AC voltage to the load.

Second power converter 4 includes a DC-DC converter 4A that receives a DC voltage from power generation element 6 and converts the received DC voltage to a DC voltage, a DC-AC inverter 4B that receives the DC voltage from DC-DC converter 4A and outputs an AC voltage to the AC terminal, an AC current adjuster 40 that adjusts AC current output from DC-AC inverter 4B, and a measurement unit 42 that measures the AC voltage on AC terminal Z.

Second controller 5 adjusts active power based on change of the state of AC terminal Z.

In the case where power generation element 6 is a solar cell or a fuel cell, discharging operation of second power converter 4 means that electric power on the basis of generated power of power generation element 6 is output to AC terminal Z of second power converter 4. There is no charging operation of second power converter 4, because power generation element 6 does not have the power storage function.

In the case where power generation element 6 is a storage battery or a flywheel, discharging operation of second power converter 4 means that electric power on the basis of electric power of discharging energy stored in power generation element 6 is output to AC terminal Z of second power converter 4. Charging operation of second power converter 4 means that energy on the basis of electric power for charging from AC terminal Z of second power converter 4 is stored in power generation element 6.

Detector 1A outputs, to first controller 3, information on the state of charge of power storage element 1.

First controller 3 instructs first power converter 10 to adjust the AC voltage on AC terminal Z in accordance with a first table based on the state of charge of power storage element 1.

Second controller 5 instructs second power converter 4 to adjust the AC current output to AC terminal Z in accordance with a second table based on change of the state of the AC voltage on AC terminal Z.

Specifically, first controller 3 instructs the first power converter to adjust the AC voltage on AC terminal Z in accordance with the first table that increases any one of the amplitude, the effective value, and the frequency of the AC voltage, as the state of charge of power storage element 1 increases, and decreases any one of the amplitude, the effective value, and the frequency of the AC voltage, as the state of charge of power storage element 1 decreases.

Second controller 5 instructs second power converter 5 to adjust AC current output to AC terminal Z, in accordance with the second table that decreases apparent power or active power or increases reactive power that is output from second power converter 5, as any one of the amplitude, the effective value, and the frequency of the AC voltage increases, or increases apparent power or active power or decreases reactive power that is output from the second power converter, as any one of the amplitude, the effective value, and the frequency of the AC voltage decreases.

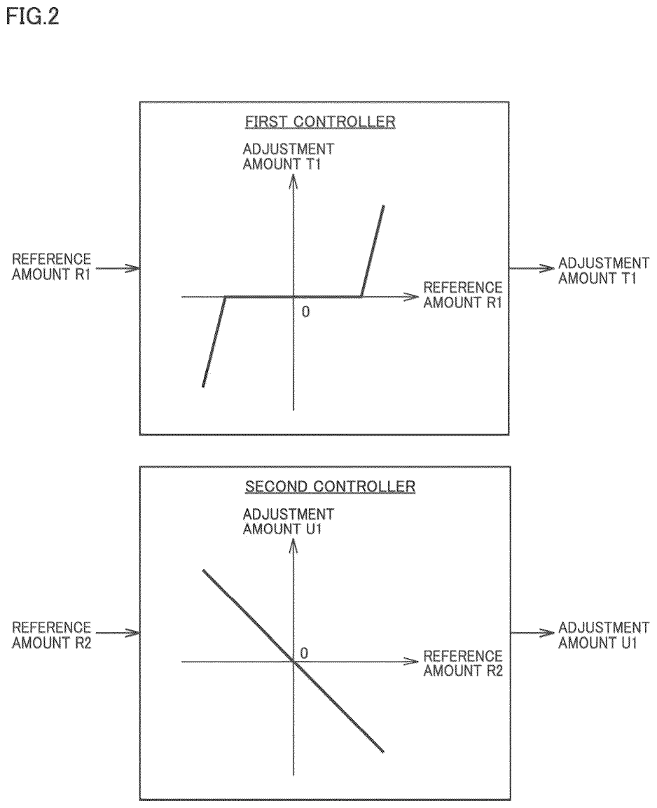

FIG. 2 is a diagram illustrating the first table and the second table for first controller 3 and second controller 5 according to Embodiment 1.

Referring to FIG. 2, first controller 3 includes the first table that outputs adjustment amount T, in response to reference amount R. For example, the first table outputs adjustment amount T1, in response to reference amount R1.

Second controller 5 includes the second table that outputs adjustment amount U, in response to reference amount R. For example, the second table outputs adjustment amount U1, in response to reference amount R2.

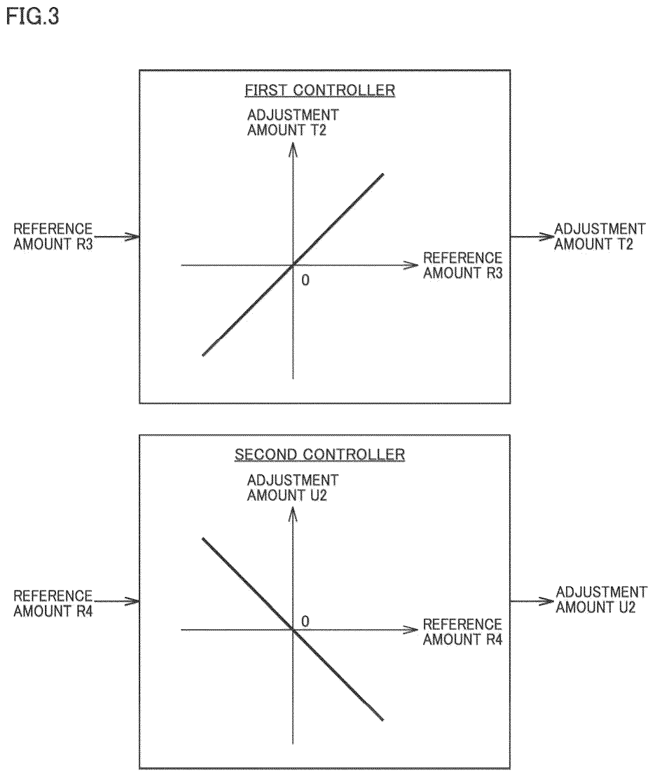

FIG. 3 is another diagram illustrating a first table and a second table for first controller 3 and second controller 5 according to Embodiment 1.

Referring to FIG. 3, first controller 3 includes a third table that outputs adjustment amount T, in response to reference amount R. For example, the third table outputs adjustment amount T2, in response to reference amount R3.

Second controller 5 includes a fourth table that outputs adjustment amount U, in response to reference amount R. For example, the second table outputs adjustment amount U2, in response to reference amount R4. It is seen from a comparison between FIG. 2 and FIG. 3 that they differ from each other in that FIG. 2 includes a dead zone, a parameter is adjusted when a predetermined threshold value is exceeded and the parameter is not adjusted until the predetermined threshold value is exceeded. They are similar to each other in other respects.

### Configuration Example 1.1

A case is described where reference amount R1 is the state of charge of power storage element 1.

A case is described where first controller 3 adjusts the amplitude of the AC voltage as adjustment amount T1, in response to input of the state of charge of power storage element 1 as reference amount R1.

A case is described where second controller 5 adjusts active power P2 as adjustment amount U1, in response to input of the amplitude of the AC voltage of second power converter 4 as reference amount R2.

A plurality of adjustment amounts may be generated based on the same reference amount.

Specifically, a case is described where first controller 3 uses the first table in FIG. 2. A case is described where second controller 5 uses the second table in FIG. 2.

Based on the first table, when the state of charge (ratio of charge) of power storage element 1 exceeds a predetermined threshold value, first controller 3 adjusts the amplitude of the AC voltage, in accordance with a difference between the ratio of charge and the threshold value.

As shown in the first table, when reference amount R1, which is the state of charge (ratio of charge) of power storage element 1, exceeds a predetermined threshold value, first controller 3 adjusts the amplitude of the AC voltage, which is adjustment amount T1. When reference amount R1 which is the state of charge (ratio of charge) is within a range of the threshold value, first controller 3 does not adjust the amplitude of the AC voltage.

In the range of the threshold value, the amplitude of the AC voltage is set to a general grid voltage amplitude, and the amplitude is adjusted on the basis of the general grid voltage amplitude. For example, the amplitude of the AC voltage may be adjusted within a range of ±10% of a reference AC voltage supplied to the load.

For example, it is supposed that S represents the ratio of charge of power storage element 1, SthH and SthL each represent a threshold value, and K1a represents a voltage amplitude adjustment gain adjusted by the ratio of charge. The state of charge (ratio of charge) of 50% is set as reference amount 0. Threshold value SthH is a threshold value for the state of overcharge. Threshold value SthL is a threshold value for the state of overdischarge.

When the ratio of charge of power storage element 1 exceeds a predetermined threshold value (when the ratio of charge is 80% or more), first controller 3 calculates amplitude Vm of the AC voltage, which is adjustment amount T1, by the following equation. In the case where a general 200V single-phase AC grid is simulated by the AC output of first power converter 10, Vm0 representing a voltage amplitude reference is set to 282 V. Voltage amplitude adjustment gain K1a may be set separately for the charging operation and the discharging operation.

In the case where the ratio of charge of power storage element 1 is a predetermined threshold value or more (state of overcharge): Vm=Vm0+K1a×(S−SthH)

In the case where the ratio of charge of power storage element 1 is a predetermined threshold value or less (state of overdischarge): Vm=Vm0+K1a×(S−SthL)

Thus, when the ratio of charge of power storage element 1 is a predetermined threshold value (SthH) or more (state of overcharge), first controller 3 increases amplitude Vm of the AC voltage.

In contrast, when the ratio of charge of power storage element 1 is a predetermined threshold value (SthL) or less (state of overdischarge), first controller 3 decreases amplitude Vm of the AC voltage.

First controller 3 outputs calculated amplitude Vm as a voltage amplitude command to AC voltage adjuster 20. AC voltage adjuster 20 adjusts the amplitude of the AC voltage output from DC-AC inverter 2B to AC terminal Z, in accordance with the command.

Second controller 5 adjusts active power in accordance with amplitude Vm of the AC voltage on AC terminal Z.

Specifically, measurement unit 42 measures the amplitude of the AC voltage on AC terminal Z. Second controller 5 adjusts the AC power based on variation of the amplitude of the AC voltage from measurement unit 42.

Based on the second table, second controller 5 adjusts active power P2 that is adjustment amount T2, in response to reference amount R2 that is amplitude Vm of the AC voltage.

Based on the second table, when amplitude Vm of the AC voltage increases from a reference value, second controller 5 decreases active power output from second power converter 4 to AC terminal Z. Second controller 5 outputs, to AC current adjuster 40, an active current command value in accordance with the second table, as an active current command. When amplitude Vm of the AC voltage is the reference value, the command value is set to 0. AC current adjuster 40 adjusts active power P2 output from DC-AC inverter 4B to AC terminal Z in accordance with the active current command from second controller 5. For example, when the active current command has a negative value in accordance with the second table, AC current adjuster 40 instructs DC-AC inverter 4B to adjust active current (decrease active current) and thereby decrease active power P2. Thus, when amplitude Vm of the AC voltage on AC terminal Z increases, second power converter 4 decreases the output of active power P2 to AC terminal Z to reduce power stored in power storage element 1, and thereby enable prevention of overcharge. When this adjustment is not enough to reduce the power stored in power storage element 1, active current is finally set to 0.

Based on the second table, when amplitude Vm of the AC voltage decreases from the reference value, second controller 5 increases active power P2 output from second power converter 4 to AC terminal Z. Second controller 5 outputs, to AC current adjuster 40, an active current command value in accordance with the second table as an active current command. AC current adjuster 40 adjusts active power P2 output from DC-AC inverter 4B to AC terminal Z in accordance with the active current command from second controller 5. For example, when the active current command has a positive value in accordance with the second table, AC current adjuster 40 instructs DC-AC inverter 4B to adjust active current (increase active current) so as to increase active power P2. Thus, when amplitude Vm of the AC voltage on AC terminal Z decreases, second power converter 4 increases output of active power P2 to AC terminal Z to reduce power discharged to power storage element 1, and thereby enable prevention of overdischarge. The adjustment of active power P2 is performed within a range of output that can be generated by power generation element 6 and, when the value of adjustment of active power P2 is larger than the maximum power that can be output by power generation element 6 and the rated power of second power converter 4, for example, power that is more than or equal to the power that can be output by power generation element 6 and second power converter 4 may not be output.

The first and second tables in FIG. 3 can be used as well to perform the above-described process.

Further, in the case where amplitude Vm of the AC voltage is the reference value, a current value on the basis of generated power of the power generation element may be set as a reference for the active current command value.

### Configuration Example 1.2

A case is described where second controller 5 adjusts reactive power Q2 as adjustment amount U1, in response to input of the amplitude of the AC voltage of second power converter 4 as reference amount R2.

A plurality of adjustment amounts may be generated based on the same reference amount.

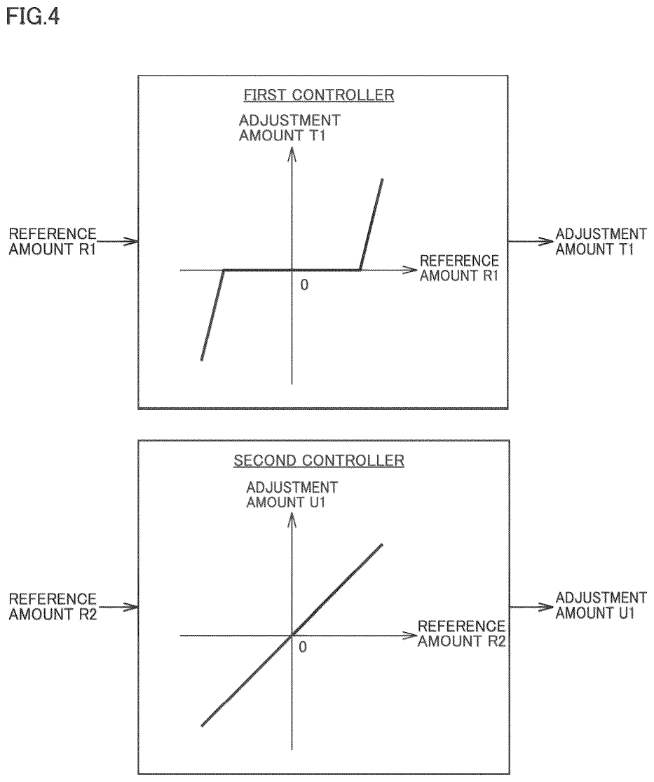

FIG. 4 is still another diagram illustrating first and second tables for first controller 3 and second controller 5 according to Embodiment 1.

Referring to FIG. 4, first controller 3 includes the first table that outputs adjustment amount T, in response to reference amount R. For example, the first table outputs adjustment amount T1, in response to reference amount R1.

Second controller 5 includes the second table that outputs adjustment amount U, in response to reference amount R. For example, the second table outputs adjustment amount U1, in response to reference amount R2.

The first table is similar to the first table in FIG. 2, and therefore, the description of its operation is not herein repeated.

The second table is different in that adjustment amount U1 is increased as reference amount R2 increases.

Second controller 5 uses the second table to adjust reactive power Q2 in response to amplitude Vm of the AC voltage on AC terminal Z.

Based on the second table, second controller 5 adjusts reactive power Q2 that is adjustment amount T2, in response to reference amount R2 that is amplitude Vm of the AC voltage.

When the ratio of charge of power storage element 1 is a predetermined threshold value or more (state of overcharge), first controller 3 increases amplitude Vm of the AC voltage.

In contrast, when the ratio of charge of power storage element 1 is a predetermined threshold value or less (state of overdischarge), first controller 3 decreases amplitude Vm of the AC voltage.

First controller 3 outputs the calculated amplitude Vm as a voltage amplitude command to AC voltage adjuster 20. AC voltage adjuster 20 adjusts the amplitude of the AC voltage output from DC-AC inverter 2B to AC terminal Z, in accordance with the command.

Second controller 5 adjusts reactive power in response to amplitude Vm of the AC voltage on AC terminal Z.

Specifically, measurement unit 42 measures the amplitude of the AC voltage on AC terminal Z. Second controller 5 adjusts the AC power based on variation of the amplitude of the AC voltage from measurement unit 42.

Based on the second table, second controller 5 increases reactive power output from second power converter 4 to AC terminal Z, when amplitude Vm of the AC voltage increases from a reference value. Second controller 5 outputs, to AC current adjuster 40, a reactive current command value in accordance with the second table, as a reactive current command. When amplitude Vm of the AC voltage is the reference value, the command value is set to 0. The reactive current command value output from second power converter 4 to AC terminal Z is set to a current value on the basis of generated power of the power generation element. AC current adjuster 40 adjusts the reactive power output from DC-AC inverter 4B to AC terminal Z, in accordance with the reactive current command from second controller 5. For example, when the reactive current command has a positive value in accordance with the second table, AC current adjuster 40 instructs DC-AC inverter 4B to adjust reactive current (increase reactive current) and thereby increase reactive power Q2. Thus, in the case where second power converter 4 has a function of indirectly decreasing the active power so as not to exceed the rated value of apparent power of second power converter 4 by increasing the reactive power, second power converter 4 increases, when amplitude Vm of the AC voltage on AC terminal Z increases, the output of reactive power Q2 to AC terminal Z to reduce power stored in power storage element 1, and thereby enable prevention of overcharge.

Based on the second table, when amplitude Vm of the AC voltage decreases from the reference value, second controller 5 decreases the reactive power output from second power converter 4 to AC terminal Z. Second controller 5 outputs, to AC current adjuster 40, a reactive current command value in accordance with the second table as a reactive current command. AC current adjuster 40 adjusts reactive power Q2 output from DC-AC inverter 4B to AC terminal Z in accordance with the reactive current command from the second controller 5. For example, when the reactive current command has a negative value in accordance with the second table, AC current adjuster 40 instructs DC-AC inverter 4B to adjust reactive current (decrease reactive current) so as to decrease reactive power Q2. Thus, in the case where second power converter 4 has a function of indirectly increasing the active power so as not to exceed the rated value of apparent power of second power converter 4 by decreasing the reactive power, second power converter 4 decreases, when amplitude Vm of the AC voltage on AC terminal Z decreases, the output of reactive power Q2 to AC terminal Z to reduce power discharged to power storage element 1, and thereby enable prevention of overdischarge. The adjustment of reactive power Q2 is performed within a range of output that can be generated by power generation element 6 and, when the value of adjustment of the reactive power is larger than the maximum power that can be output by power generation element 6 and the rated power of second power converter 4, for example, power that is more than or equal to the power that can be output by power generation element 6 and second power converter 4 may not be output.

The first table in FIG. 3 and the second table in FIG. 4 can be used as well to perform the above-described process.

As seen from the above, according to the above-described configurations, the adjustment of active power P2 or reactive power Q2 of second power converter 4 is used to suppress overcharge or overdischarge of first power converter 10, and thus it is possible to make second power converter 4 cooperate indirectly depending on operation of first power converter 10. For Configuration Example 1, the effective value of the AC voltage can also be used instead of the amplitude of the AC voltage as adjustment amount T1, to obtain similar advantageous effects.

While the foregoing illustrates adjustment of the active current or the reactive current by second controller 5b, both of the active current and the reactive current may be adjusted instead of one of them.

Specifically, the active power may be decreased and the reactive power may be increased as amplitude Vm of the AC voltage on AC terminal Z increases. The active power may be increased and the reactive power may be decreased as amplitude Vm of the AC voltage on AC terminal Z decreases.

### Configuration Example 2.1

A case is described where reference amount R1 is the state of charge of power storage element 1.

A case is described where first controller 3 adjusts the frequency of the AC voltage as adjustment amount T, in response to input of the state of charge of power storage element 1 as reference amount R1.

A case is described where second controller 5 adjusts active power P2 as adjustment amount U1, in response to the frequency of the AC voltage of second power converter 4 as reference amount R2.

A plurality of adjustment amounts may be generated based on the same reference amount.

Specifically, a case is described where first controller 3 uses the first table in FIG. 2. A case is described where second controller 5 uses the second table in FIG. 2.

Based on the first table, when the state of charge (ratio of charge) of power storage element 1 exceeds a predetermined threshold value, first controller 3 adjusts the frequency of the AC voltage, in accordance with a difference between the ratio of charge and the threshold value.

As shown in the first table, when reference amount R1, which is the state of charge (ratio of charge) of power storage element 1, exceeds a predetermined threshold value, first controller 3 adjusts the frequency of the AC voltage, which is adjustment amount T1. When reference amount R1 which is the state of charge (ratio of charge) is within a range of the threshold value, first controller 3 does not adjust the frequency of the AC voltage.

In the range of the threshold value, the frequency of the AC voltage is set to a general grid voltage frequency, and the frequency is adjusted on the basis of the general grid voltage frequency. For example, the frequency of the AC voltage may be adjusted within a range of ±10% of a reference frequency of the AC voltage supplied to the load.

For example, it is supposed that S represents the ratio of charge of first power converter 10, SthH and SthL each represent a threshold value, and K1b represents a frequency adjustment gain adjusted by the ratio of charge. The state of charge (ratio of charge) of 50% is set as reference amount 0. Threshold value SthH is a threshold value for the state of overcharge. Threshold value SthL is a threshold value for the state of overdischarge.

When the ratio of charge of power storage element 1 exceeds a predetermined threshold value, first controller 3 calculates frequency f of the AC voltage, which is adjustment amount T1, by the following equation. In the case where a general 200V single-phase AC grid is simulated by the AC output of first power converter 10, frequency f0 is set to 50 Hz or 60 Hz. Frequency adjustment gain K1b may be set separately for the charging operation and the discharging operation.

In the case where the ratio of charge of power storage element 1 is a predetermined threshold value or more (state of overcharge): f=f0+K1b×(S−Sth)

In the case where the ratio of charge of power storage element 1 is a predetermined threshold value or less (state of overdischarge): f=f0+K1b×(S−Sth)

Thus, when the ratio of charge of power storage element 1 is a predetermined threshold value or more (state of overcharge), first controller 3 increases frequency f of the AC voltage.

In contrast, when the ratio of charge of power storage element 1 is a predetermined threshold value or less (state of overdischarge), first controller 3 decreases frequency f of the AC voltage.

First controller 3 outputs calculated frequency f as a voltage frequency command to AC voltage adjuster 20. AC voltage adjuster 20 adjusts the frequency of the AC voltage output from DC-AC inverter 2B to AC terminal Z, in accordance with the command.

Second controller 5 adjusts active power P2 in response to frequency f of the AC voltage on AC terminal Z.

Specifically, measurement unit 42 measures frequency f of the AC voltage on AC terminal Z. Second controller 5 adjusts the AC power based on variation of the frequency of the AC voltage from measurement unit 42.

Based on the second table, second controller 5 adjusts active power P2 that is adjustment amount T2, in response to reference amount R2 that is frequency f of the AC voltage.

Based on the second table, when frequency f of the AC voltage increases from a reference value, second controller 5 decreases active power P2 output from second power converter 4 to AC terminal Z. Second controller 5 outputs, to AC current adjuster 40, an active current command value in accordance with the second table, as an active current command. When frequency f of the AC voltage is the reference value, the command value is set to 0. AC current adjuster 40 adjusts active power P2 output from DC-AC inverter 4B to AC terminal Z in accordance with the active current command from second controller 5. For example, when the active current command has a negative value in accordance with the second table, AC current adjuster 40 instructs DC-AC inverter 4B to adjust active current (decrease active current) and thereby decrease active power P2. Thus, when frequency f on AC terminal Z increases, second power converter 4 decreases the output of active power P2 to AC terminal Z to reduce power stored in power storage element 1, and thereby enable prevention of overcharge. When this adjustment is not enough to reduce power stored in power storage element 1, active current is finally set to 0.

Based on the second table, when frequency f of the AC voltage decreases from the reference value, second controller 5 increases active power P2 output from second power converter 4 to AC terminal Z. Second controller 5 outputs, to AC current adjuster 40, an active current command value in accordance with the second table as an active current command. AC current adjuster 40 adjusts active power P2 output from DC-AC inverter 4B to AC terminal Z in accordance with the active current command from second controller 5. For example, when the active current command has a positive value in accordance with the second table, AC current adjuster 40 instructs DC-AC inverter 4B to adjust active current (increase active current) so as to increase active power P2. Thus, when frequency f of the AC voltage on AC terminal Z decreases, second power converter 4 increases output of active power P2 to AC terminal Z to reduce power discharged to power storage element 1, and thereby enable prevention of overdischarge. The adjustment of active power P2 is performed within a range of output that can be generated by power generation element 6 and, when the value of adjustment of active power P2 is larger than the maximum power that can be output by power generation element 6 and the rated power of second power converter 4, for example, power that is more than or equal to the power that can be output by power generation element 6 and second power converter 4 may not be output.

The first and second tables in FIG. 3 can be used as well to perform the above-described process.

Further, in the case where frequency f of the AC voltage is the reference value, a current value on the basis of generated power of the power generation element may be set as a reference for the active current command value.

### Configuration Example 2.2

A case is described where second controller 5 adjusts reactive power Q2 as adjustment amount U1, in response to input of the frequency of the AC voltage of second power converter 4 as reference amount R2.

A plurality of adjustment amounts may be generated based on the same reference amount.

First controller 3 uses the first table in FIG. 2 to adjust the frequency of the AC voltage as adjustment amount T1, in response to input of the state of charge of power storage element 1 as reference amount R1.

Based on the second table, second controller 5 adjusts reactive power Q2 that is adjustment amount T2, in response to reference amount R2 that is the frequency of the AC voltage.

Specifically, measurement unit 42 measures the frequency of the AC voltage on AC terminal Z. Second controller 5 adjusts the AC power based on variation of the frequency of the AC voltage from measurement unit 42.

Based on the second table, when the frequency of the AC voltage increases from a reference value, second controller 5 increases reactive power output from second power converter 4 to AC terminal Z. Second controller 5 outputs, to AC current adjuster 40, a reactive current command value in accordance with the second table, as a reactive current command. When the frequency of the AC voltage is the reference value, the command value is set to 0. The reactive current command value output from second power converter 4 to AC terminal Z is set to a current value on the basis of generated power of the power generation element. AC current adjuster 40 adjusts reactive power Q2 output from DC-AC inverter 4B to AC terminal Z, in accordance with the reactive current command from second controller 5. For example, when the reactive current command is a positive value in accordance with the second table, AC current adjuster 40 instructs DC-AC inverter 4B to increase reactive power Q2. Thus, in the case where second power converter 4 has a function of indirectly decreasing the active power so as not to exceed the rated value of apparent power of second power converter 4 by increasing the reactive power, second power converter 4 increases, when the frequency of the AC voltage on AC terminal Z increases, the output of reactive power Q2 to AC terminal Z to reduce power stored in power storage element 1, and thereby enable prevention of overcharge.

Based on the second table, when the frequency of the AC voltage decreases from the reference value, second controller 5 decreases reactive power Q2 output from second power converter 4 to AC terminal Z. Second controller 5 outputs, to AC current adjuster 40, a reactive current command value in accordance with the second table as a reactive current command. AC current adjuster 40 adjusts reactive power Q2 output from DC-AC inverter 4B to AC terminal Z in accordance with the reactive current command from second controller 5. For example, when the reactive current command has a negative value in accordance with the second table, AC current adjuster 40 instructs DC-AC inverter 4B to decrease reactive power Q2. Thus, in the case where second power converter 4 has a function of indirectly decreasing the active power so as not to exceed the rated value of apparent power of second power converter 4 by increasing reactive power Q2, second power converter 4 decreases, when the frequency of the AC voltage on AC terminal Z decreases, the output of reactive power Q2 to AC terminal Z to reduce power discharged to power storage element 1, and thereby enable prevention of overdischarge. The adjustment of reactive power Q2 is performed within a range of output that can be generated by power generation element 6 and, when the value of adjustment of reactive power Q2 is larger than the maximum power that can be output by power generation element 6 and the rated power of second power converter 4, for example, power that is more than or equal to the power that can be output by power generation element 6 and second power converter 4 may not be output.

The first table in FIG. 3 and the second table in FIG. 4 can be used as well to perform the above-described process.

While the foregoing illustrates adjustment of the active current or the reactive current by second controller 5b, both of the active current and the reactive current may be adjusted instead of one of them.

Specifically, active power P2 may be decreased and reactive power Q2 may be increased as the frequency of the AC voltage on AC terminal Z increases. Active power P2 may be increased and reactive power Q2 may be decreased as the frequency of the AC voltage on AC terminal Z decreases.

While the above description of Configuration Example 2 illustrates the case where the frequency of the AC voltage is adjusted as adjustment amount T1, the phase may be adjusted instead of the frequency.

Power conversion system 100 of Embodiment 1 causes second power converter 4 to cooperate indirectly with first power converter 10 to thereby achieve power interchange between the power converters, and makes use of second power converter 4 to thereby improve operational continuity of first power converter 10 that generates the AC voltage.

Power conversion system 100 of Embodiment 1 has a function of adjusting second power converter 4 by second controller 5, in accordance with a cooperative element generated, through first controller 3, by first power converter 10 connected to power storage element 1, as well as a detection value relating to the cooperative element detected by second power converter 4 connected to power generation element 6, so that power storage element 1 and power generation element 6 can be adjusted in cooperation to suppress abrupt change of power supply and, factors of stoppage of AC voltage generation by first power converter 10 can be alleviated, so that stable power supply to connected loads can be achieved.

### Embodiment 2

The above description of Embodiment 1 illustrates a method for adjusting the AC voltage output to AC terminal Z in accordance with the state of charge (ratio of charge) of power storage element 1.

In connection with Embodiment 2, a method for measuring the state of charge of power storage element 1 from an internal state of first power converter 10 is described.

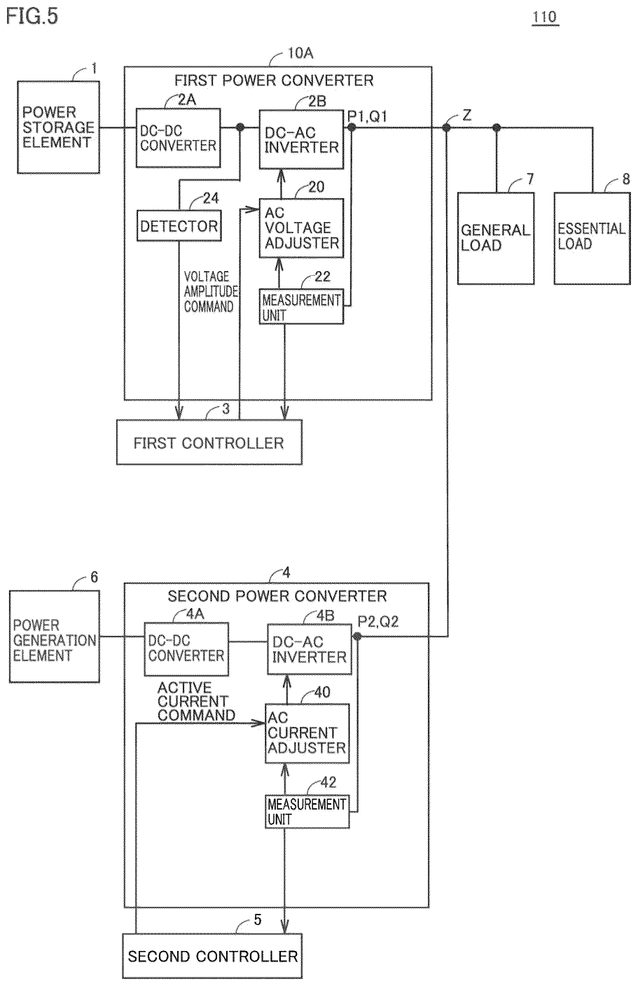

FIG. 5 is a diagram illustrating a configuration of a power conversion system 110 according to Embodiment 2.

As shown in FIG. 5, power conversion system 110 is different in that first power converter 10 is replaced with a first power converter 10A. It is also different in that detector 1A is not provided. It should be noted that detector 1A may be provided in the configuration.

First power converter 10A is different from first power converter 10 in that the former further includes a detector 24. Detector 24 detects an internal state value of first power converter 10A. Specifically, detector 24 detects a value of the DC voltage that is an output of DC-DC converter 2A.

For example, detector 24 may detect the voltage on a terminal of a capacitor which is similar to an energy buffer where the output voltage of DC-DC converter 2A increases.

The output voltage of DC-DC converter 2A increases with increase of the state of charge of power storage element 1. Therefore, the output voltage of DC-DC converter 2A, which is an internal state value, can be detected to detect the state of charge of power storage element 1.

First controller 3 instructs first power converter 10 to adjust the AC voltage on AC terminal Z, in accordance with the first table based on the output voltage of DC-DC converter 2A.

Second controller 5 instructs second power converter 4 to adjust the AC current output to AC terminal Z, in accordance with the second table based on change in the state of the AC voltage on AC terminal Z.

A case is described where reference amount R1 is the output voltage of DC-DC converter 2A.

A case is described where first controller 3 adjusts the amplitude of the AC voltage as adjustment amount T1, in response to input of the input of the output voltage of DC-DC converter 2A as reference amount R1.

A case is described where second controller 5 adjusts active power as adjustment amount U1, in response to input of the amplitude of the AC voltage of second power converter 4 as reference amount R2.

A plurality of adjustment amounts may be generated based on the same reference amount.

Specifically, a case is described where first controller 3 uses the first table in FIG. 2. A case is described where second controller 5 uses the second table in FIG. 2.

Based on the first table, when the output voltage of DC-DC converter 2A exceeds a predetermined threshold value, first controller 3 adjusts the amplitude of the AC voltage, in accordance with a difference between the output voltage and the threshold value.

When the device internal value (DC voltage) of first power converter 10A exceeds a predetermined threshold value, first controller 3 adjusts the amplitude of the AC voltage in accordance with a difference between the device internal value and the threshold value. In the range of the threshold value, the amplitude of the AC voltage is set to a general grid voltage and the amplitude is adjusted on the basis of the general grid voltage amplitude.

As shown in the first table, when reference amount R1, which is the device internal value (DC voltage), exceeds a predetermined threshold value, first controller 3 adjusts the amplitude of the AC voltage, which is adjustment amount T1. When reference amount R1 which is the device internal value (DC voltage) is within a range of the threshold value, first controller 3 does not adjust the amplitude of the AC voltage.

For example, it is supposed that X represents the DC voltage on a terminal of a capacitor similar to an energy buffer where the voltage increases due to an operational restriction or the like of first power converter 10, Xth represents a threshold value of first controller 3, and K1g represents a voltage amplitude adjustment gain adjusted by the device internal value.

A case is described where first controller 3 uses the first table in FIG. 2.

Amplitude Vm of the AC voltage, which is adjustment amount T1, is determined by the following equation. In the case where a general 200V single-phase AC grid is simulated by the AC output of first power converter 10, Vm0 representing a voltage amplitude reference is set to 282 V. Voltage amplitude adjustment gain K1g may be set separately for two terms, i.e., the state of charge and the charging/discharging operation of power storage element 1, through an energy management system or the like.

$$Vm = Vm 0 + K 1 g \times ( X - Xth )$$

Thus, first controller 3 increases amplitude Vm of the AC voltage when the device internal value exceeds a predetermined threshold value (when the DC voltage is a predetermined threshold value or more) (state of overcharge).

Second controller 5 adjusts active power P2 in accordance with the amplitude on AC terminal Z to which second power converter 4 is connected.

Specifically, measurement unit 42 measures the amplitude of the AC voltage on AC terminal Z. Second controller 5 adjusts the AC power based on variation of the amplitude of the AC voltage from measurement unit 42.

Based on the second table, second controller 5 adjusts active power P2 that is adjustment amount T2, in accordance with reference amount R2 that is amplitude Vm of the AC voltage

Based on the second table, when amplitude Vm of the AC voltage increases from a reference value, second controller 5 decreases active power P2 output from second power converter 4 to AC terminal Z. Second controller 5 outputs, to AC current adjuster 40, an active current command value in accordance with the second table, as an active current command. When amplitude Vm of the AC voltage is the reference value, the command value is set to 0. AC current adjuster 40 adjusts active power P2 output from DC-AC inverter 4B to AC terminal Z in accordance with the active current command from second controller 5. For example, when the active current command has a negative value in accordance with the second table, AC current adjuster 40 instructs DC-AC inverter 4B to adjust active current (reduce active current) and thereby decrease active power P2. Thus, when amplitude Vm of the AC voltage on AC terminal Z increases, second power converter 4 decreases the output of the active power to AC terminal Z to reduce power stored in power storage element 1, and thereby enable prevention of overcharge. When this adjustment is not enough to reduce the power stored in power storage element 1, active current is finally set to 0.

The first and second tables in FIG. 3 can be used as well to perform the above-described process.

Further, in the case where amplitude Vm of the AC voltage is the reference value, a current value on the basis of generated power of the power generation element may be set as a reference for the active current command value.

While the foregoing illustrates that second controller 5 adjusts active power P2 which is adjustment amount T2, based on the second table in accordance with reference amount R2 which is amplitude Vm of the AC voltage, it may adjust reactive power Q2.

Specifically, based on the second table, second controller 5 increases reactive power Q2 output from second power converter 4 to AC terminal Z, when amplitude Vm of the AC voltage increases from a reference value. Second controller 5 outputs, to AC current adjuster 40, a reactive current command value in accordance with the second table, as a reactive current command. When amplitude Vm of the AC voltage is the reference value, the command value is set to 0. The reactive current command value output from second power converter 4 to AC terminal Z is set to a current value on the basis of generated power of the power generation element. AC current adjuster 40 adjusts reactive power Q2 output from DC-AC inverter 4B to AC terminal Z, in accordance with the reactive current command from second controller 5. For example, when the reactive current command has a positive value in accordance with the second table, AC current adjuster 40 instructs DC-AC inverter 4B to adjust reactive current (increase reactive current) and thereby increase the reactive power. Thus, in the case where second power converter 4 has a function of indirectly decreasing the active power so as not to exceed the rated value of apparent power of second power converter 4 by increasing the reactive power, second power converter 4 increases, when amplitude Vm of the AC voltage on AC terminal Z increases, the output of reactive power Q2 to AC terminal Z, to reduce power stored in power storage element 1, and thereby enable prevention of overcharge.

The effective value of the AC voltage can also be used instead of the amplitude of the AC voltage as adjustment amount T1, to obtain similar advantageous effects. Further, instead of the amplitude of the AC voltage as adjustment amount T1, the frequency may be adjusted as well.

### Embodiment 3

The above description of Embodiment 2 illustrates the case where the output voltage of DC-DC converter 2A is used as an internal state value of first power converter 10A.

The temperature of first power converter 10A may also be used as an internal state value of first power converter 10A.

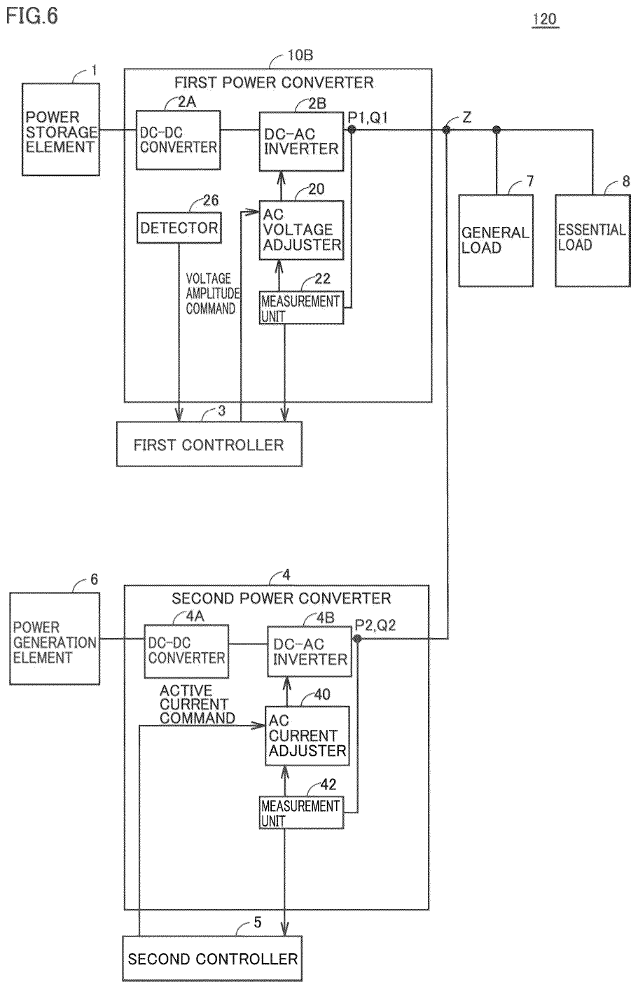

FIG. 6 is a diagram illustrating a configuration of a power conversion system 120 according to Embodiment 3.

As shown in FIG. 6, power conversion system 120 is different in that first power converter 10 is replaced with a first power converter 10B. It is also different in that detector 1A is not provided. It should be noted that detector 1A may be provided in the configuration.

First power converter 10B differs from first power converter 10 in that the former further includes a detector 26. Detector 26 detects an internal state value of first power converter 10A. Specifically, detector 26 detects the temperature of the inside of first power converter 10A. For instance, the temperature of various components such as DC-DC converter 2A may be detected, as an example of the internal state value.

The higher the temperature of first power converter 10A, the higher the possibility of occurrence of abnormality in first power converter 10A.

First controller 3 instructs first power converter 10 to adjust the AC voltage on AC terminal Z in accordance with the first table based on the temperature detected by detector 26.

Second controller 5 instructs second power converter 4 to adjust AC current output to AC terminal Z in accordance with the second table based on change in the state of the AC voltage on AC terminal Z.

A case is described where reference amount R1 is the temperature from detector 26.

A case is described where first controller 3 adjusts the amplitude of the AC voltage as adjustment amount T1, in response to input of the temperature from detector 26 as reference amount R1.

A case is described where second controller 5 adjusts active power P2 as adjustment amount U1, in response to input of the amplitude of the AC voltage of second power converter 4 as reference amount R2.

A plurality of adjustment amounts may be generated based on the same reference amount.

Specifically, a case is described where first controller 3 uses the first table in FIG. 2. A case is described where second controller 5 uses the second table in FIG. 2.

Based on the first table, when the temperature from detector 26 exceeds a predetermined threshold value, first controller 3 adjusts the amplitude of the AC voltage, in accordance with a difference between the temperature and the threshold value.

When the device internal value (temperature) of first power converter 10A exceeds a predetermined threshold value, first controller 3 adjusts the amplitude of the AC voltage, in accordance with a difference between the device internal value and the threshold value. In a range of the threshold value, the amplitude of the AC voltage is set to a general grid voltage amplitude, and the amplitude is adjusted on the basis of the general grid voltage amplitude.

As shown in the first table, when reference amount R1, which is the device internal value (temperature), exceeds a predetermined threshold value, first controller 3 adjusts the amplitude of the AC voltage, which is adjustment amount T1. When reference amount R1 which is the device internal value (temperature) is within a range of the threshold value, first controller 3 does not adjust the amplitude of the AC voltage.

For example, it is supposed that Y represents the temperature from detector 26 of first power converter 10, Yth represents the threshold value for first controller 3, and K1h represents a voltage amplitude adjustment gain adjusted by the device internal value.

A case is described where first controller 3 uses the first table in FIG. 2.

Amplitude Vm of the AC voltage which is adjustment amount T1 is determined by the following equation. In the case where a general 200V single-phase AC grid is simulated by the AC output of first power converter 10, Vm0 representing a voltage amplitude reference is set to 282 V. Voltage amplitude adjustment gain K1h may be set separately for two terms, i.e., the state of charge and the charging/discharging operation of power storage element 1, through an energy management system or the like.

$$Vm = Vm 0 + K 1 h \times ( Y - Yth )$$

Thus, when the device internal value exceeds a predetermined threshold value (the temperature is the predetermined threshold value or more), first controller 3 increases amplitude Vm of the AC voltage.

Second controller 5 adjusts active power P2 in accordance with the amplitude at AC terminal Z to which second power converter 4 is connected.

Specifically, measurement unit 42 measures the amplitude of the AC voltage on AC terminal Z. Second controller 5 adjusts the AC power based on variation of the amplitude of the AC voltage from measurement unit 42.

Based on the second table, second controller 5 adjusts active power P2 that is adjustment amount T2, in accordance with reference amount R2 that is amplitude Vm of the AC voltage.

Based on the second table, when amplitude Vm of the AC voltage increases from a reference value, second controller 5 decreases active power P2 output from second power converter 4 to AC terminal Z. Second controller 5 outputs, to AC current adjuster 40, an active current command value in accordance with the second table, as an active current command. When amplitude Vm of the AC voltage is the reference value, the command value is set to 0. AC current adjuster 40 adjusts active power P2 output from DC-AC inverter 4B to AC terminal Z in accordance with the active current command from second controller 5. For example, when the active current command has a negative value in accordance with the second table, AC current adjuster 40 instructs DC-AC inverter 4B to adjust active current (reduce active current) and thereby decrease active power P2. Thus, when amplitude Vm of the AC voltage on AC terminal Z increases, second power converter 4 can decrease the output of active power P2 to AC terminal Z to reduce power input to first power converter 10B. Accordingly, increase of the temperature resultant from increase of the amount of input power can be reduced. When this adjustment is not enough to reduce the amount of input power, active current is finally set to 0.

The first and second tables in FIG. 3 can be used as well to perform the above-described process.

Further, in the case where amplitude Vm of the AC voltage is the reference value, a current value on the basis of generated power of the power generation element may be set as a reference for the active current command value.

While the foregoing illustrates that second controller 5 adjusts active power P2 which is adjustment amount T2, based on the second table in accordance with reference amount R2 which is amplitude Vm of the AC voltage, it may adjust reactive power Q2.

Specifically, based on the second table, second controller 5 increases reactive power Q2 output from second power converter 4 to AC terminal Z, when amplitude Vm of the AC voltage increases from a reference value. Second controller 5 outputs, to AC current adjuster 40, a reactive current command value in accordance with the second table, as a reactive current command. When amplitude Vm of the AC voltage is the reference value, the command value is set to 0. The reactive current command value output from second power converter 4 to AC terminal Z is set to a current value on the basis of generated power of the power generation element. AC current adjuster 40 adjusts reactive power Q2 output from DC-AC inverter 4B to AC terminal Z, in accordance with the reactive current command from second controller 5. For example, when the reactive current command has a positive value in accordance with the second table, AC current adjuster 40 instructs DC-AC inverter 4B to adjust reactive current (increase reactive current) and thereby increase the reactive power. Thus, in the case where second power converter 4 has a function of indirectly decreasing the active power so as not to exceed the rated value of apparent power of second power converter 4 by increasing the reactive power, second power converter 4 increases, when amplitude Vm of the AC voltage on AC terminal Z increases, the output of reactive power Q2 to AC terminal Z, to reduce power input to first power converter 10B. Accordingly, increase of the temperature resultant from increase of the amount of input power can be reduced.

The effective value of the AC voltage can also be used instead of the amplitude of the AC voltage as adjustment amount T1, to obtain similar advantageous effects. Further, instead of the amplitude of the AC voltage as adjustment amount T1, the frequency may be adjusted as well.

### Embodiment 4

Embodiment 4 relates to a power conversion system including a plurality of power storage elements.

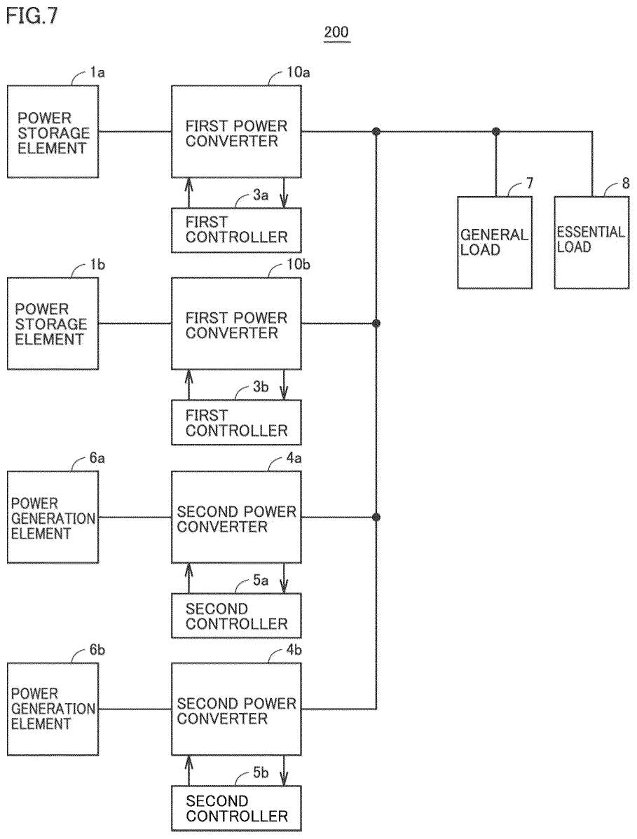

FIG. 7 is a diagram illustrating a configuration of a power conversion system 200 according to Embodiment 4. As shown in FIG. 7, power conversion system 200 includes power storage elements 1a, 1b, first power converters 10a, 10b that receive respective voltages of power storage elements 1a, 1b to output respective AC voltages, first controllers 3a, 3b that adjust respective AC voltages, second power converters 4a, 4b that each discharge power to an AC terminal, and second controllers 5a, 5b that receive respective AC voltages to adjust power, and power generation elements 6a, 6b are connected to respective input terminals of second power converters 4a, 4b, respectively, and a general load 7 and an essential load 8 are connected to the terminal of the AC voltage.

First controllers 3a, 3b have a similar configuration to first controller 3 illustrated in Embodiment 1. The width of the dead zone and the gradient representing a relation between reference amount R1 and adjustment amount T1 may each have a different value. The detector that detects the state of charge of the power storage element is not shown.

Second controllers 5a, 5b have a similar configuration to second controller 5 illustrated in Embodiments 1 to 3. The gradient representing a relation between reference amount R2 and adjustment amount U1 may have a different value.

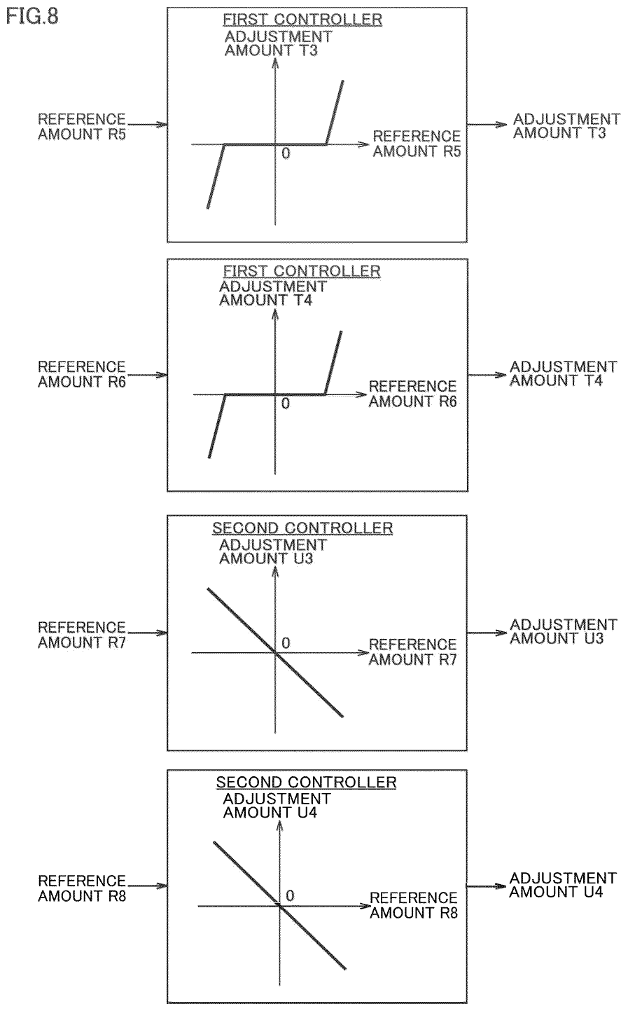

FIG. 8 is a diagram illustrating adjustment of parameters by first controllers 3a, 3b and second controllers 5a, 5b according to Embodiment 4.

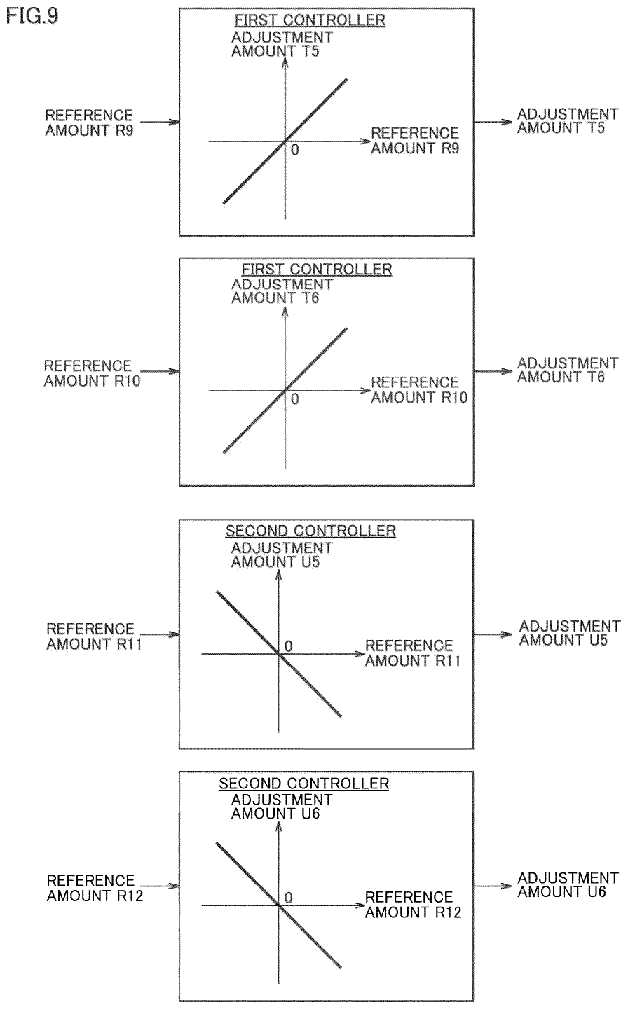

FIG. 9 is a diagram illustrating another adjustment of parameters by first controllers 3a, 3b and second controllers 5a, 5b according to Embodiment 4.

The tables in FIGS. 8 and 9 are basically similar to those described in connection with FIGS. 2 and 3, and therefore, the detailed description thereof is not herein repeated.

Even the configuration made up of a plurality of sets is applicable in a similar manner to Embodiments 1 to 3.

A case is described where first controllers 3a, 3b adjust the frequency of the AC voltage on the AC terminal as adjustment amounts T3, T4, in response to active power of the AC voltage of first power converters 10a, 10b as reference amounts R5, R6.

A case is described where second controllers 5a, 5b adjust the active power of the AC voltage of second power converters 4a, 4b as adjustment amounts U3, U4, in response to the frequency of the AC voltage on the AC terminal as reference amounts R7, R8.

A case is described where the tables in FIG. 8 are used.

When the active power of the AC voltage of first power converters 10a, 10b exceeds a predetermined threshold value, first controllers 3a, 3b adjust the frequency of the AC voltage, in accordance with a difference between the active power and the threshold value. In a range of the threshold value, the frequency of the AC voltage is set to a general grid frequency, and the frequency is adjusted on the basis of the general grid voltage frequency.

Gains KXa, KXb used in the tables in FIG. 8 are determined on the basis of ratio of charge S of power storage elements 1a, 1b, respectively. It may be a fixed value without depending on the ratio of charge. Similarly, threshold value Pth of the active power may be determined on the basis of ratio of charge S of power storage elements 1a, 1b.

Second controllers 5a, 5b adjust the active power of the AC voltage of second power converters 4a, 4b, in response to the frequency of the AC voltage on the AC terminal.

Gains KYa, KYb used in the tables in FIG. 8 may be fixed values.

Then, it is supposed that PXa represents the active power of power converter 10a, and PXb represents the active power of power converter 10b.

It is supposed that PLa and PLb represent power consumption of general load 7 and that of essential load 8, respectively, and PYa0 and PYb0 represent the active power output from power converters 4a and that from power converter 4b at reference frequency f0, respectively.

Active power PYa and active power PYb of power converters 4a and 4b can be expressed by the following equations.

Here, dF represents a width of frequency change from reference frequency f0.

$$PYa = PYa 0 - KYa \times dF$$

$$PYb = PYb 0 - KYb \times dF$$

The relation of power supply at the AC terminal is calculated by the following equation.

$$PXa + PXb + PYa + PYb = PLa + PLb$$

When PXa≥Pth and PXb≥Pth are satisfied for discharging operation of power storage elements 1a, 1b, dF is calculated by the following equation.

$$d F = KXa \times ( PXa - Pth ) = KXb \times ( PXb - Pth )$$

The relation of power demand/supply is calculated by the following equation.

$$dF / KXa + dF / KXb + 2 Pth = PLa + PLb - Pya 0 - Pyb 0 + ( Kya - Kyb ) \times dF$$

The above equation is expanded to calculate dF by the following equation.

$$dF = ( PLa + PLb - Pya 0 - Pyb 0 - 2 Pth ) / ( 1 / KXa + 1 / KXb - Kya - Kyb )$$

For suppressing overdischarge, it is necessary to increase the power discharged from power generation elements 6a, 6b, as the power discharged from power storage elements 1a, 1b increases. Therefore, dF needs to take a negative value. That is, frequency f1 is lower than reference frequency f0.

When PXa≤−Pth and PXb≤−Pth are satisfied for charging operation of power storage elements 1a, 1b, dF is calculated by the following equation.

$$dF = KXa \times ( PXa + Pth ) = KXb \times ( PXb + Pth )$$

The relation of power demand/supply is calculated by the following equation.

$$dF / KXa + dF / KXb - 2 Pth = PLa + PLb - Pya 0 - Pyb 0 + ( Kya - Kyb ) \times dF$$

The above equation is expanded to calculate dF by the following equation.

$$dF = ( PLa + PLb - Pya 0 - Pyb 0 + 2 Pth ) / ( 1 / KXa + 1 / KXb - Kya - Kyb )$$

For preventing overcharge, it is necessary to reduce the discharge power from power generation elements 6a, 6b, as the charge power of power storage elements 1a, 1b increases. Therefore, dF needs to take a positive value. That is, frequency f1 is higher than reference frequency f0.

Second controllers 5a, 5b adjust the active power in accordance with the frequencies at AC terminals Z to which second power converters 4a, 4b are connected respectively.

As described above, frequency f1 (=f0+dF) is determined as a value that depends on the settings of first controllers 3a, 3b and second controllers 5a, 5b.

Accordingly, interchange of active power between a plurality of first power converters and a plurality of second power converters in the power conversion system according to Embodiment 4 is achieved, similarly to Embodiments 1 to 3.

Although the present disclosure describes various exemplary embodiments and examples, various features, aspects, and functions described in one or more embodiments are not limited to a particular embodiment, but are applicable either alone or in various combinations to the embodiments.

Numerous modifications that are not illustrated herein are therefore contemplated within the scope of the disclosed art. For example, modification, addition, or removal of at least one component, and a combination of at least one extracted component and a component of another embodiment, are included therein.

It should be construed that embodiments disclosed herein are given by way of illustration in all respects, not by way of limitation. It is intended that the scope of the present disclosure is defined by claims, not by the description above, and encompasses all modifications and variations equivalent in meaning and scope to the claims.

### REFERENCE SIGNS LIST

1, 1a, 1b power storage element; 2, 2a, 2b first power converter; 3, 3a, 3b first controller; 4, 4a, 4b second power converter; 5, 5a, 5b second controller; 6, 6a, 6b power generation element; 7 general load; 8 essential load; 100, 200 power conversion system

1. A power conversion system comprising:
a power storage element;
a first power converter connected between the power storage element and a load, to control charging and discharging of the power storage element, and output an AC voltage to the load;
a first controller to control the first power converter;
a power generation element to supply generated power;
a second power converter connected, at an AC terminal, to the load in parallel with the first power converter, to output an AC voltage to the load; and
a second controller to control the second power converter, wherein
the first power converter includes an AC voltage adjuster to adjust an AC voltage output to the AC terminal,
the second power converter includes an AC current adjuster to adjust AC current output to the AC terminal,
the first controller outputs, to the AC voltage adjuster, an instruction for the first power converter to adjust the AC voltage on the AC terminal, in accordance with a first table that increases any one of an amplitude and an effective value of the AC voltage, as a state of charge of the power storage element increases, and that decreases any one of the amplitude and the effective value of the AC voltage, as the state of charge of the power storage element decreases, and
the second controller outputs, to the AC current adjuster, an instruction for the second power converter to adjust the AC current output to the AC terminal, in accordance with a second table that decreases apparent power or active power or increases reactive power that is output from the second power converter, as any one of the amplitude and the effective value of the AC voltage increases, and that increases apparent power or active power or decreases reactive power that is output from the second power converter, as any one of the amplitude and the effective value of the AC voltage decreases.

2. (canceled)

3. The power conversion system according to claim 1, wherein
the first controller instructs the first power converter to adjust the AC voltage on the AC terminal, in accordance with the first table that increases any one of the amplitude and the effective value of the AC voltage, as the state of charge of the power storage element increases when the state of charge of the power storage element is a predetermined threshold value or more, and that decreases any one of the amplitude and the effective value of the AC voltage, as the state of charge of the power storage element decreases when the state of charge of the power storage element is a predetermined threshold value or less, and
the second controller instructs the second power converter to adjust the AC current output to the AC terminal, in accordance with the second table that decreases apparent power or active power or increases reactive power that is output from the second power converter, as any one of the amplitude and the effective value of the AC voltage increases, and that increases apparent power or active power or decreases reactive power that is output from the second power converter, as any one of the amplitude and the effective value of the AC voltage decreases.

4. The power conversion system according to claim 1, wherein
a plurality of sets of configurations each made up of the power storage element, the first power converter, and the first controller are provided, and
the plurality of sets of configurations are connected in parallel to the AC terminal.

5. The power conversion system according to claim 1, comprising a detector to detect a ratio of charge of the power storage element, wherein
the first controller instructs the first power converter to adjust the AC voltage on the AC terminal in accordance with the first table based on the ratio of charge from the detector.

6. (canceled)

7. A power conversion system comprising:
a power storage element;
a first power converter connected between the power storage element and a load, to control charging and discharging of the power storage element, and output an AC voltage to the load;
a first controller to control the first power converter;
a power generation element to supply generated power;
a second power converter connected, at an AC terminal, to the load in parallel with the first power converter, to output an AC voltage to the load;
a second controller to control the second power converter; and
a detector to detect an internal state of the first power converter, wherein
the first power converter includes:
a converter unit to receive a voltage from the power storage element and output a DC voltage; and
an inverter unit to receive the DC voltage from the converter unit and output the AC voltage,
the detector detects, as an internal state of the first power converter, the DC voltage output from the converter,
the first controller instructs the first power converter to adjust the AC voltage on the AC terminal, in accordance with a first table that increases any one of an amplitude, an effective value, and a frequency of the AC voltage, as the DC voltage of the first power converter detected by the detector increases, and
the second controller instructs the second power converter to adjust the AC current output to the AC terminal, in accordance with a second table that decreases apparent power or active power or increases reactive power that is output from the second power converter, as any one of the amplitude, the effective value, and the frequency of the AC voltage increases.

8. A power conversion system comprising:
a power storage element;
a first power converter connected between the power storage element and a load, to control charging and discharging of the power storage element, and output an AC voltage to the load;
a first controller to control the first power converter;
a power generation element to supply generated power;
a second power converter connected, at an AC terminal, to the load in parallel with the first power converter, to output an AC voltage to the load;
a second controller to control the second power converter; and
a detector to detect an internal temperature of the first power converter, wherein
the first controller instructs the first power converter to adjust the AC voltage on the AC terminal, in accordance with a first table that increases any one of an amplitude, an effective value, and a frequency of the AC voltage, as an internal temperature of the first power converter detected by the detector increases, and
the second controller instructs the second power converter to adjust the AC current output to the AC terminal, in accordance with a second table that decreases apparent power or active power or increases reactive power that is output from the second power converter, as any one of the amplitude, the effective value, and the frequency of the AC voltage increases.
